(19) United States
(12) Patent Application Publication
(10) Pub. No.: US 2006/0232151 A1
(43) Pub. Date: Oct. 19, 2006

(54) Slip ring end housing for a dual rectifier alternator

(76) Inventor: Randy P. DuBois, Comstock Park, MI (US)

Correspondence Address: LITMAN LAW OFFICES, LTD, PO BOX 15035, CRYSTAL CITY STATION, ARLINGTON, VA, 22215, US

(21) Appl. No.: 11/106,556

(22) Filed: Apr. 15, 2005

(51) Int. Cl. H02K 1/32; H02K 3/24; H02K 5/18

(52) U.S. Cl. 310/68 D; 310/64

(57) ABSTRACT

A Slip Ring End (SRE) housing for a dual rectifier alternator. The SRE housing includes a base with an outer surface and an inner surface. A first rectifier is attached to the outer surface of the base. A second rectifier is attached to the inner surface of the base. A connector passes through the base and electrically interconnects the first rectifier to the second rectifier. The SRE housing includes standoffs. The standoffs can be integrally formed on the outer surface of the base. The first and second rectifiers can include six diodes. A plurality of fasteners attaches the first rectifier to the outer surface of the base and the second rectifier to the inner surface of the base. An insulator shield can be provided for the first rectifier and an insulator shield can be provided for the second rectifier. An alternator can be interconnected to the SRE housing.

### BACKGROUND OF THE INVENTION

1. Field of the Invention

The present invention generally relates to alternators and, more particularly, to a Slip Ring End housing for a dual rectifier alternator.

2. Description of Related Art

Alternators have been used since the 1960s to supply electricity to charge the battery and to power various electrical equipment of vehicles, such as passenger cars, trucks, boats, etc. Such alternators commonly employ diode bridge rectifier platforms to change the electrical current produced by the vehicle alternator from alternating current (AC) to direct current (DC). Diode bridge rectifiers typically incorporate six semiconductor diodes. The diodes are mounted on a heat sink plate in close proximity to the alternator where temperature and vibration are high. When alternators first appeared, power requirements were typically about five hundred watts. This power demand escalated to about fifteen hundred watts in the 1980s. Today, many production alternators are capable of providing about two thousand watts and designs are being developed that provide upwards of about three thousand watts of electrical output power.

Accompanying this increase in electrical performance has been a proportional increase in heat loss of the rectifier bridge since its thermal losses are essentially linear with output power. With constant worldwide pressure to drive the overall alternator cost down, the package size of the alternator per unit of electrical output power continually shrinks and places greater demand on package size of the alternator. The proliferation of aftermarket add-on electrical equipment also pushes demand far beyond the capacity of single rectifier alternators.

Typical alternators include the system integrated (SI) 10SI, 12SI, 15SI, 17SI, 21SI, 22SI, 27SI, charging system (CS) CS130, and CS144. The most common alternator ever produced is the 10SI. The 10SI was first introduced at 37 amps maximum output and was later upgraded to 61 amps as power demands increased for vehicles. As the power demands continued to increase, vehicle manufacturers continued to upgrade with the 12SI and the larger 17SI that had a maximum output of 120 amps. The CS-144 alternator has been upgraded to 140 amps. The larger unit and higher output still has not been enough in some demanding situations to keep rectifier bridges of alternators from failing. Even with the six diodes upgraded to the maximum amperage rating possible the bridge rectifier of alternators is still the number one component to fail in high demand situations using only one rectifier.

With the demands for higher electrical power, higher inlet cooling temperatures, smaller package sizes, increased reliability, lower cost, and lower noise, there remains an ever-increasing thermal energy design challenge to cool power electronics in alternators. Therefore, a need exists for a Slip Ring End housing for a dual rectifier alternator.

### SUMMARY OF THE INVENTION

The present invention is a Slip Ring End (SRE) housing for a dual rectifier alternator. The SRE housing includes a base with an outer surface and an inner surface. A first rectifier is attached to the outer surface of the base. A second rectifier is attached to the inner surface of the base. A connector passes through the base and electrically interconnects the first rectifier to the second rectifier.

The SRE housing can be configured in the form of an SRE housing selected from the group consisting of a 10SI, 12SI, 15SI, 17SI, 21SI, 22SI, 27SI, CS130, and CS144 alternator housing. The SRE housing includes standoffs. The standoffs can be integrally formed on the outer surface of the base. The first and second rectifiers can include six diodes. A plurality of fasteners attach the first rectifier to the outer surface of the base and the second rectifier to the inner surface of the base. An insulator shield can be provided for the first rectifier and an insulator shield can be provided for the second rectifier. An alternator can be interconnected to the SRE housing.

An SRE housing method provides an SRE housing with a base with an outer surface and an inner surface, attaches a first rectifier to the outer surface of the base, attaches a second rectifier to the inner surface of the base, and electrically interconnects the first rectifier to the second rectifier with a connector that passes through the base.

The SRE housing method can further configure the SRE housing in the form of an SRE housing selected from the group consisting of a 10SI, 12SI, 15SI, 17SI, 21SI, 22SI, 27SI, CS130, and CS144 alternator housing. The SRE housing method can further provide standoffs, which can be integrally formed on the outer surface of the base. The SRE housing method can further provide the first and second rectifiers with six diodes. The SRE housing method can further attach the first rectifier to the outer surface of the base with a plurality of fasteners, and can attach the second rectifier to the inner surface of the base with a plurality of fasteners. The SRE housing method can further provide an insulator shield for the first rectifier and can further provide an insulator shield for the second rectifier. The SRE housing method can further interconnect an alternator with the SRE housing.

### BRIEF DESCRIPTION OF THE DRAWINGS

FIG. 1 is a front perspective view of an SRE housing for a dual rectifier alternator according to the present invention.

FIG. 2 is a top view of the SRE housing shown in FIG. 1.

FIG. 3 is a bottom view of the SRE housing shown in FIG. 1.

FIG. 4 is an exploded view of the SRE housing shown in FIG. 1.

FIG. 5 is a sectional view of the connector that interconnects the first and second rectifiers shown in FIG. 4.

FIG. 6 is a front perspective view of an SRE housing for a dual rectifier alternator according to the present invention.

FIG. 7 is a top view of the SRE housing shown in FIG. 6.

FIG. 8 is a bottom view of the SRE housing shown in FIG. 6.

FIG. 9 is an exploded view of the SRE housing shown in FIG. 6.

Similar reference characters denote corresponding features consistently throughout the attached drawings.

### DETAILED DESCRIPTION OF THE PREFERRED EMBODIMENTS

The present invention is an SRE housing for a dual rectifier alternator. The invention disclosed herein is, of course, susceptible of embodiment in many different forms. Shown in the drawings and described herein below in detail are preferred embodiments of the invention. It is to be understood, however, that the present disclosure is an exemplification of the principles of the invention and does not limit the invention to the illustrated embodiments.

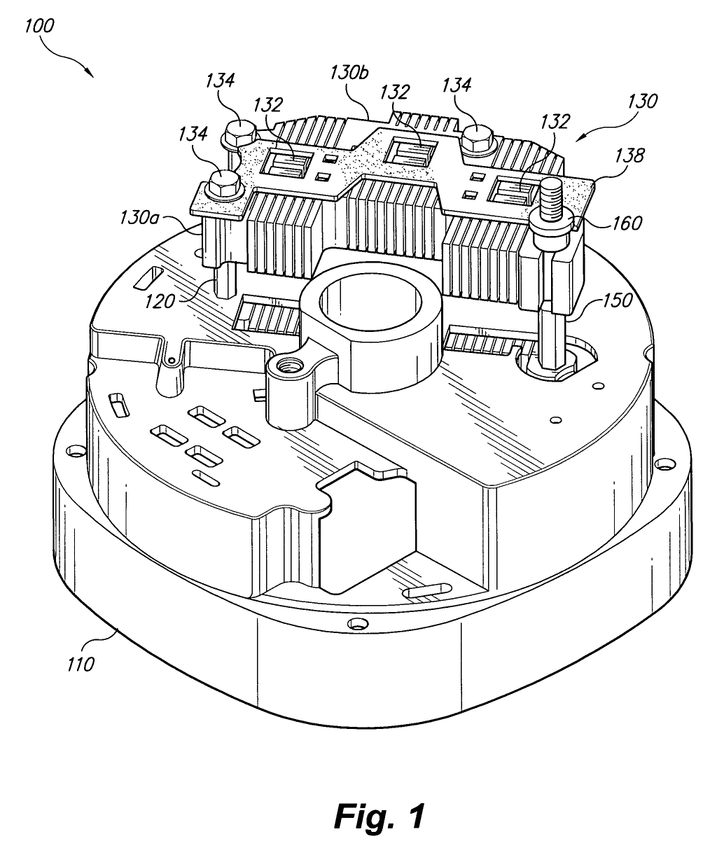

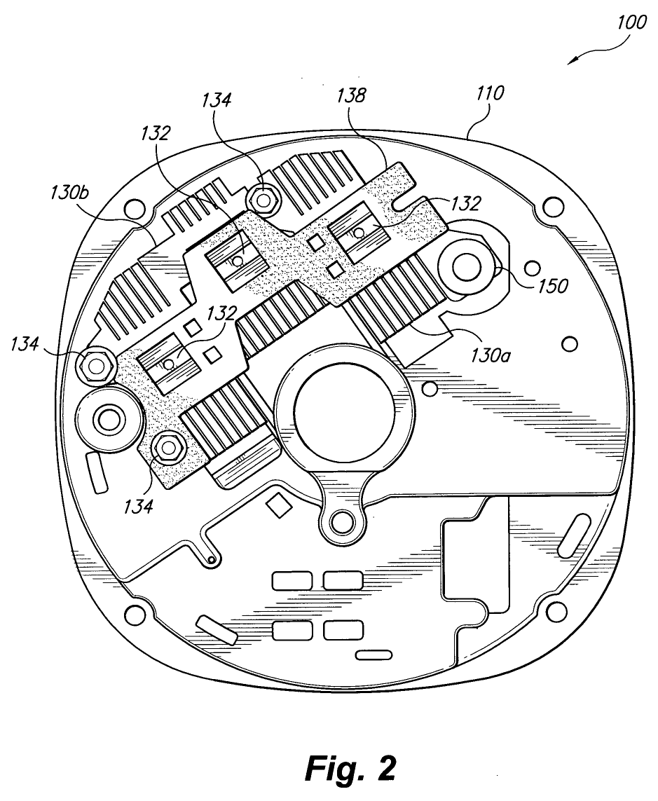

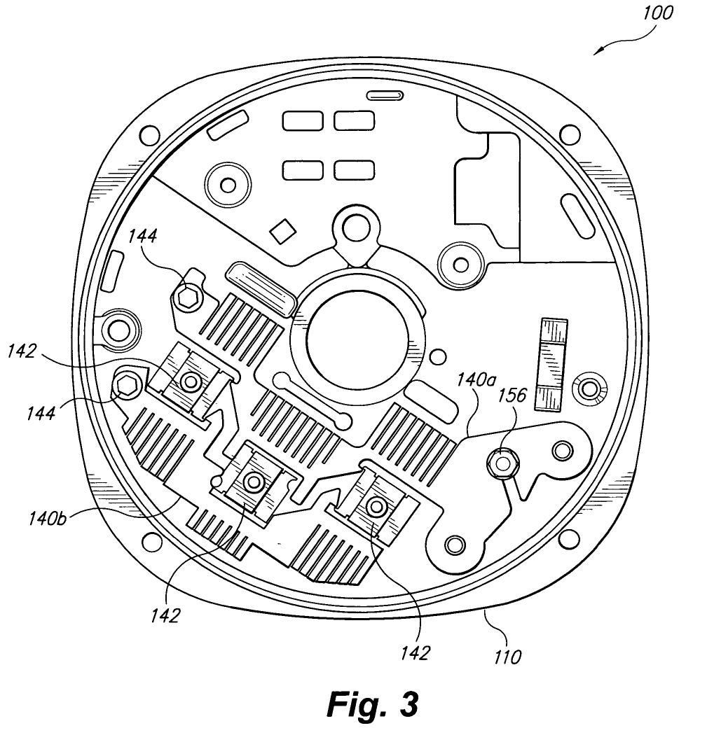

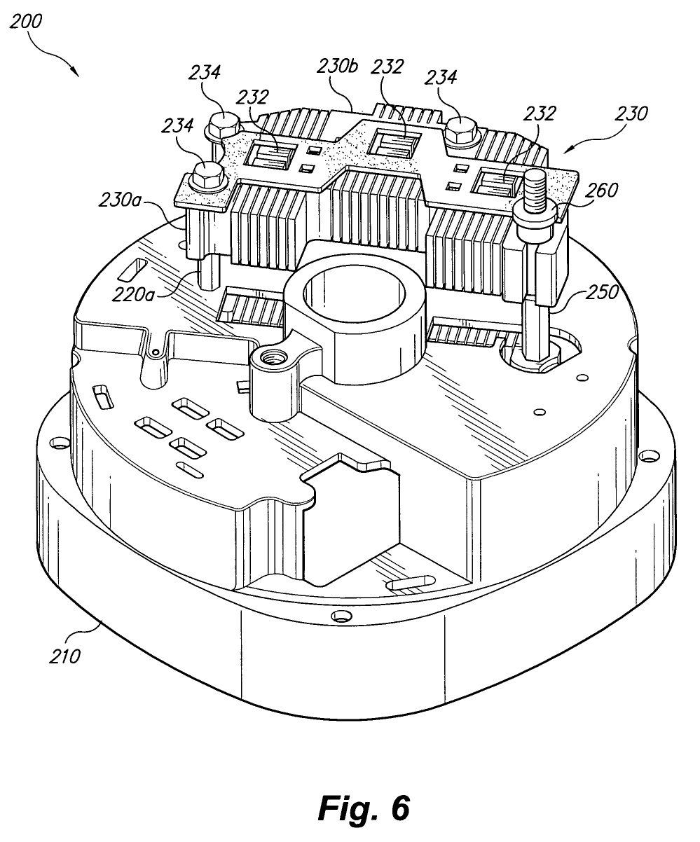

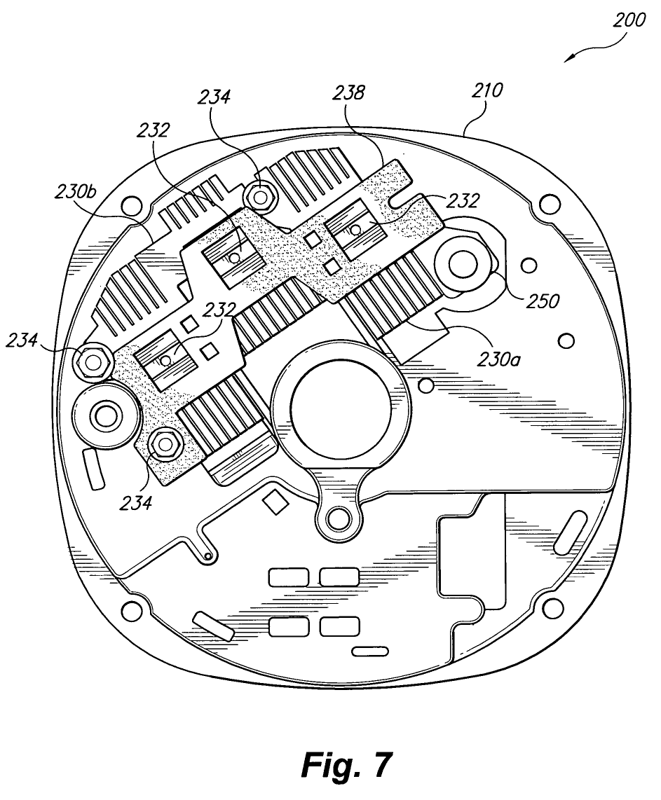

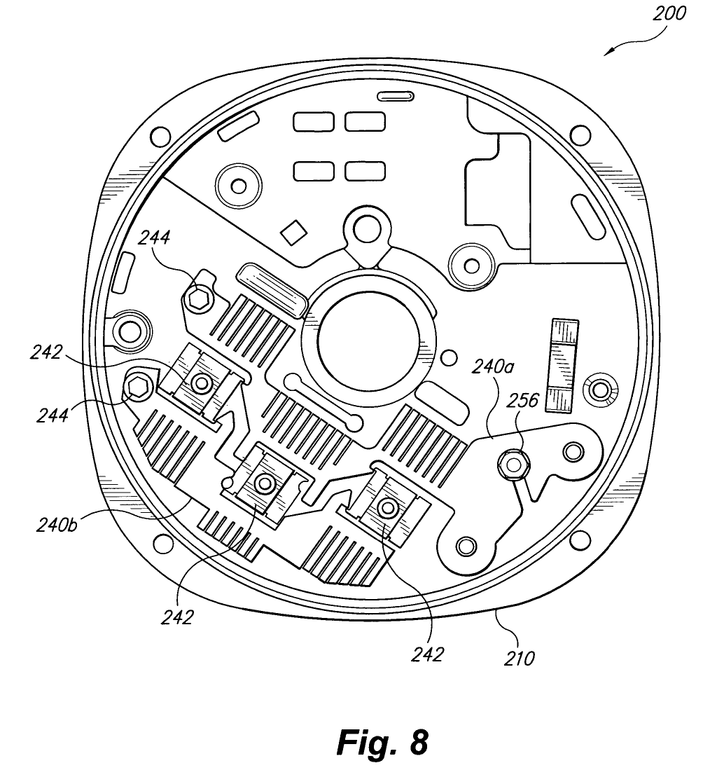

Referring to the drawings, FIGS. 1-5 show an example of an SRE housing 100 and FIGS. 6-9 show another example of an SRE housing 200 for dual rectifier alternators according to the present invention. The SRE housings 100 vehicle, such as a car, truck, boat, etc. It is the full intent of the inventor that the teachings of the present invention described below with respect to the SRE housings 100 and 200 can be applied to any desired SRE housing for an alternator of a vehicle according to the desires of the user. For example, the teachings described below can be applied to model number 10SI, 12SI, 15SI, 17SI, 21SI, 22SI, 27SI, CS130, and CS144 alternator housings, as well as any other SRE housing.

The SRE housing 100 shown in FIGS. 1-4 is configured to replace an existing SRE housing of an alternator and provides the alternator with dual rectifiers 130 and 140. The dual rectifiers, hereinafter called the first rectifier 130 and the second rectifier 140, are electrically connected in parallel to provide rectifier redundancy in the event of a rectifier failure of either one of the first and second rectifiers 130 and 140. The SRE housing 100 can be provided in the form of a preassembled kit to facilitate the replacement of an existing SRE housing on an alternator by users.

The SRE housing 100 has a base 110 with an outer surface and an inner surface. The base 110 is adapted for attachment to the body of the alternator and has a plurality of openings defined therethrough for accommodating various components, for providing ventilation and/or for enabling the base 110 to conveniently mate with other engine components. The first rectifier 130 has a heat sink body formed of thermally conductive material and is attached to cast standoffs or bosses 120 integrally formed on the outer surface of the base 110. The second rectifier 140 has a heat sink body formed of thermally conductive material and is attached to the inner surface of the base 110. The base 110 and the standoffs 120 are integrally formed of metal. The base 110 has a substantially cylindrical sidewall.

A pass-through connector 150 extends through the base 110 and electrically interconnects the first and second rectifiers 130 and 140 in parallel. The cooling efficiency of the SRE housing 100 is dramatically increased over existing SRE housings by providing the first rectifier 130 on standoffs 120 on the outer surface of the base 110 and the second rectifier 140 on the inner surface of the base 110. The electrical energy capacity of an alternator to which the SRE housing 100 is attached is also greatly enhanced.

The first rectifier 130 is separated into two rectifier halves 130a and 130b. For the SRE housing 100, one rectifier half 130a is electrically connected to the positive battery terminal and one rectifier half 130b is connected to the negative battery terminal or is electrically grounded. The first rectifier 130 includes three pairs of positive and negative polarity diodes 132, or a total of six diodes, that form a rectifier bridge. The positive diodes of the diode pairs 132 are electrically connected to the positive rectifier half 130a and the negative diodes of the diode pairs 132 are electrically connected to the negative or grounded rectifier half 130b.

The first rectifier 130 rectifies or changes AC current into DC current. To rectify the current of the stator of an alternator, each of the three windings of the stator becomes interconnected with one positive and negative diode pair 132. The rectifier 130 allows current to flow from the alternator to the battery, but does not allow current to flow from the battery to the alternator.

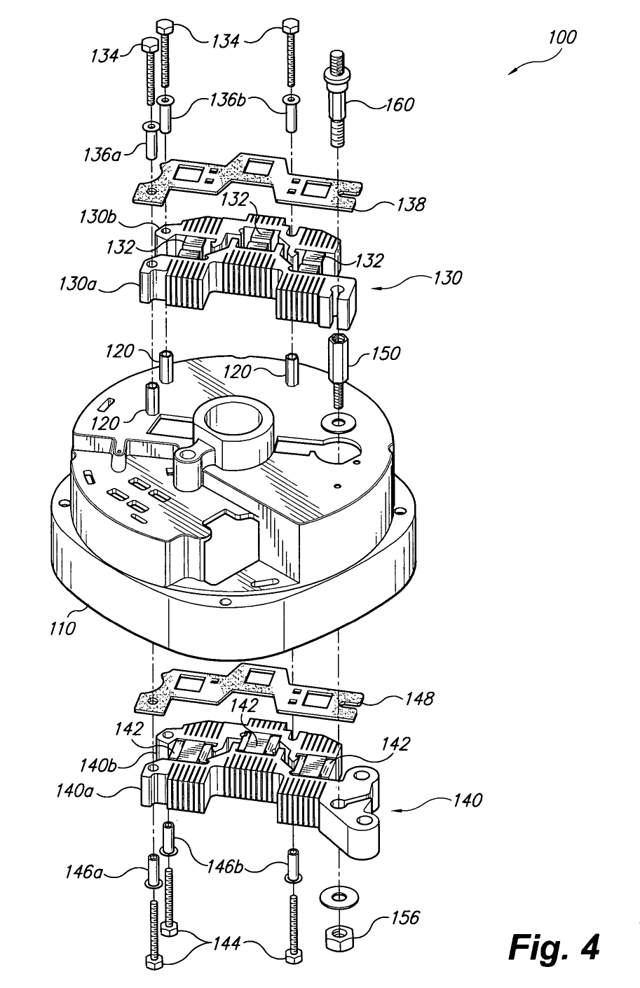

The standoffs 120 are internally threaded and the rectifier 130 is attached to the standoffs 120 by threaded fasteners 134 (e.g., screws, bolts, or the like). The fasteners 134 pass through insulator sleeves 136a and 136b made of non-conductive material to electrically insulate the fasteners 134 from the body of the first rectifier 130. The insulator sleeves 136b shown in FIG. 4 are associated with fasteners 134 that pass through the negative or grounded rectifier half 130b. Depending on the rectifier half 130a and 130b that is positively connected or negatively connected/grounded, the use of the insulator sleeves 136a or 136b can be determined according to the desires of the user. The first rectifier 130 is also provided with an insulator shield 138 made of non-conductive material, which covers the heat sink body of the rectifier 130. A fastener 160 secures the insulator shield 138 to the first rectifier 130.

The second rectifier 140 is separated into two rectifier halves 140a and 140b. For the SRE housing 100, one rectifier half 140a is electrically connected to the positive battery terminal and one rectifier half 140b is connected to the negative battery terminal or is electrically grounded. The second rectifier 140 includes three pairs of positive and negative polarity diodes 142, or a total of six diodes, that form a rectifier bridge. The positive diodes of the diode pairs 142 are electrically connected to the positive rectifier half 140a and the negative diodes of the diode pairs 142 are electrically connected to the negative or grounded rectifier half 140b.

The second rectifier 140 also rectifies or changes AC current into DC current. The rectifier 140 is attached to the inner surface of the base 110 by threaded fasteners 144 (e.g., screws, bolts, or the like). The fasteners 144 pass through insulator sleeves 146a and 146b made of non-conductive material to electrically insulate the fasteners 144 from the body of the second rectifier 140. The insulator sleeves 146b shown in FIG. 4 are associated with fasteners 144 that pass through the negative or grounded rectifier half 140b. Depending on the rectifier half 140a and 140b that is positively connected or negatively connected/grounded, the use of the insulator sleeves 146a or 146b can be determined according to the desires of the user. The second rectifier 140 is also provided with an insulator shield 148 made of non-conductive material.

The rectifiers 130 and 140 each include a body forming a heat sink having a plurality of cooling fins to increase the overall surface areas of the heat sinks and enhance the cooling ability of air passing through the SRE housing 100. Other components of an alternator (not shown), such as the rotor, slip rings, stator, brush box, regulator, etc., that are mounted to and/or interconnected with the SRE housing 100 are well known and will not be further discussed. Such an alternator is grounded through an internal grounding system of the vehicle.

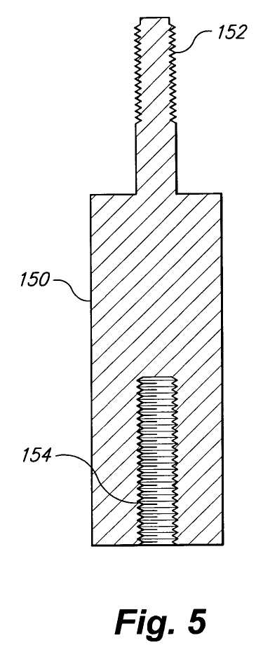

As shown in FIG. 5, the connector 150 is formed of metal or other conductive material and includes an externally threaded longitudinally extending section 152 and an internally threaded section 154. The connector 150 is configured to make electrical contact with the positive rectifier half 130a of the first rectifier 130, pass through an aperture in the base 110, and make electrical contact with the positive rectifier half 140a of the second rectifier 140.

The aperture through which the connector passes preferably has a diameter large enough to preclude the base from making contact with the connector 150. The externally threaded section 152 is configured to interconnect with an internally threaded mating element, such as a nut 156, thereby securely interconnecting the first rectifier 130 to the second rectifier 140. The second rectifier 140 also includes a section with apertures on either side of the position where the nut 156 attaches to the threaded section 152 of the connector 150 to securely attach the second rectifier 140 to the inner surface of the base 110.

The SRE housing 200 example shown in FIGS. 6-9 is configured from an existing SRE housing of an alternator and provides the alternator with dual rectifiers 230 and 240. The dual rectifiers 230 and 240, hereinafter called the first rectifier 230 and the second rectifier 240, are electrically connected in parallel to provide rectifier redundancy in the event of a rectifier failure of either one of the first and second rectifiers 230 and 240. The SRE housing 200 is essentially identical to the SRE housing 100 shown in FIGS. 1-4, except that standoffs 220 are not integral with the base 210, and a connector 250 and fastener 256 are used rather than the connector 150 and nut 156.

The SRE housing 200 has a base 210 with an outer surface and an inner surface. The base 210 has a plurality of openings defined therethrough for accommodating various components, for providing ventilation and/or for enabling the base 210 to conveniently mate with other engine components. The first rectifier 230 has a heat sink body and is attached by threaded fasteners 234 to internally threaded standoffs or bosses 220. The base 210 is configured with apertures 212 positioned to enable threaded ends of fasteners 244 to pass through and interconnect to the internally threaded standoffs 220. The base 210 has a substantially cylindrical sidewall.

A pass-through connector 250 electrically interconnects the first and second rectifiers 230 and 240 in parallel. The cooling efficiency of the SRE housing 200 is dramatically increased over existing SRE housings by providing the first rectifier 230 on the standoffs 220 on the outer surface of the base 210 and the second rectifier 240 on the inner surface of the base 210. The electrical energy capacity of an alternator to which the SRE housing 200 is attached is also greatly enhanced.

The first rectifier 230 is separated into two rectifier halves 230a and 230b. For the SRE housing 100, one rectifier half 230a is electrically connected to the positive battery terminal and one rectifier half 230b is connected to the negative battery terminal or is electrically grounded. The first rectifier 230 includes three pairs of positive and negative polarity diodes 232, or a total of six diodes, that form a rectifier bridge. The positive diodes of the diode pairs 232 are electrically connected to the positive rectifier half 230a and the negative diodes of the diode pairs 232 are electrically connected to the negative or grounded rectifier half 230b.

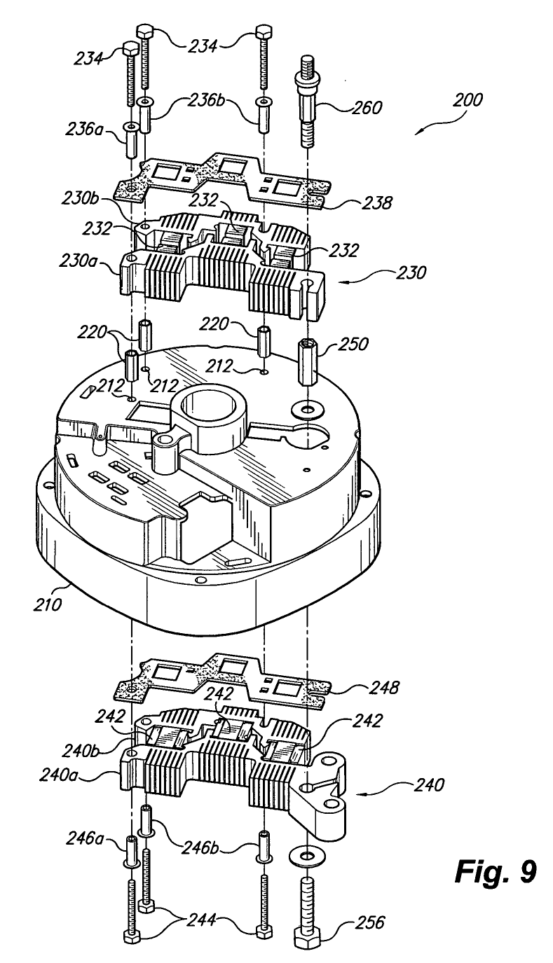

The first rectifier 230 rectifies or changes AC current into DC current. The standoffs 220 can be machined and have a threaded interior. The rectifier 230 is attached to the standoffs 220 by threaded fasteners 234 (e.g., screws, bolts, or the like). The fasteners 234 pass through insulator sleeves 236a and 236b made of non-conductive material to electrically insulate the fasteners 234 from the body of the second rectifier 230. The insulator sleeves 236b shown in FIG. 9 are associated with fasteners 234 that pass through the negative or grounded rectifier half 230b. Depending on the rectifier half 230a and 230b that is positively connected or negatively connected/grounded, the use of the insulator sleeves 236a or 236b can be determined according to the desires of the user. The first rectifier 230 is also provided with an insulator shield 238 made of non-conductive material. A fastener 260 secures the insulator shield 238 to the first rectifier 230 and interconnects with the connector 250.

The second rectifier 240 is separated into two rectifier halves 240a and 240b. For the SRE housing 200, one rectifier half 240a is electrically connected to the positive battery terminal and one rectifier half 240b is connected to the negative battery terminal or is electrically grounded. The second rectifier 240 includes three pairs of positive and negative polarity diodes 242, or a total of six diodes, that form a rectifier bridge. The positive diodes of the diode pairs 242 are electrically connected to the positive rectifier half 240a and the negative diodes of the diode pairs 242 are electrically connected to the negative or grounded rectifier half 240b.

The second rectifier 240 also rectifies or changes AC current into DC current. The rectifier 240 is attached to the inner surface of the base 210 by threaded fasteners 244 (e.g., screws, bolts, or the like). The fasteners 244 pass through insulator sleeves 246a and 246b made of non-conductive material to electrically insulate the fasteners 244 from the second rectifier 240. The insulator sleeves 246b shown in FIG. 9 are associated with fasteners 244 that pass through the negative or grounded rectifier half 240b. Depending on which rectifier half 240a and 240b is positively connected or negatively connected/grounded, the use of the insulator sleeves 246a or 246b can be determined according to the desires of the user. The second rectifier 240 is also provided with an insulator shield 248 made of non-conductive material.

The fasteners 244 pass through apertures formed in the base 210 and threadingly attach to the standoffs 220. The second rectifier 240 also includes a section with apertures on either side of the position where the nut 256 attaches to the threaded section 252 of the connector 250 to securely attach the second rectifier 240 to the inner surface of the base 210.

The rectifiers 230 and 240 each include a body forming a heat sink having a plurality of cooling fins to increase the overall surface areas of the heat sinks and enhance the cooling ability of air passing through the SRE housing 200. Other components of an alternator (not shown), such as the rotor, slip rings, stator, brush box, regulator, etc., that are mounted to and/or interconnected with the SRE housing 200 are well known and will not be further discussed. Such an alternator is grounded through an internal grounding system of the vehicle.

The connector 250 is formed of metal or other conductive material and includes an internally threaded section. The connector 250 is configured to interconnect with fastener 260, make electrical contact with the positive rectifier half 230a of the first rectifier 230, pass through an aperture in the base 210, make electrical contact with the positive rectifier half 240a of the second rectifier 240, and interconnect with fastener 256. The aperture through which the connector 260 passes preferably has a diameter large enough to preclude the base from making contact with the connector 250. The second rectifier 240 also includes a section with apertures on either side of the position where the fastener 256 is located to securely attach the second rectifier 240 to the inner surface of the base 210.

In summary, the present invention is an SRE housing for a dual rectifier alternator. The SRE housing includes a base with an outer surface and an inner surface. A first rectifier is attached to the outer surface of the base. A second rectifier is attached to the inner surface of the base. A connector passes through the base and electrically interconnects the first rectifier to the second rectifier.

The SRE housing can be configured in the form of an SRE housing selected from the group consisting of a 10SI, 12SI, 15SI, 17SI, 21SI, 22SI, 27SI, CS130, and CS144 alternator housing. The SRE housing includes standoffs. The standoffs can be integrally formed on the outer surface of the base. The first and second rectifiers can include six diodes. A plurality of fasteners attach the first rectifier to the outer surface of the base and the second rectifier to the inner surface of the base. An insulator shield can be provided for the first rectifier and an insulator shield can be provided for the second rectifier. An alternator can be interconnected to the SRE housing.

An SRE housing method provides an SRE housing with a base with an outer surface and an inner surface, attaches a first rectifier to the outer surface of the base, attaches a second rectifier to the inner surface of the base, and electrically interconnects the first rectifier to the second rectifier with a connector that passes through the base.

The SRE housing method can further configure the SRE housing in the form of an SRE housing selected from the group consisting of a 10SI, 12SI, 15SI, 17SI, 21SI, 22SI, 27SI, CS130, and CS144 alternator housing. The SRE housing method can further provide standoffs, which can be integrally formed on the outer surface of the base. The SRE housing method can further provide the first and second rectifiers with six diodes. The SRE housing method can further attach the first rectifier to the outer surface of the base with a plurality of fasteners, and can attach the second rectifier to the inner surface of the base with a plurality of fasteners. The SRE housing method can further provide an insulator shield for the first rectifier and can further provide an insulator shield can be provided for the second rectifier. The SRE housing method can further interconnect an alternator with the SRE housing.

The use of dual rectifiers on the SRE housing that provide twelve diodes spreads the current load over a much larger area making an alternator interconnected with the SRE housing twice as durable and twice as efficient at converting the AC current to DC current. Other benefits include less heat build up, less current loss, higher amperage output when hot, more power at idle, etc. The service duty and life increases substantially. When the rectifiers heat up, the diodes do not pass as much amperage through time, and therefore, the amperage output drops. With the added benefit of integrally forming the SRE housing with the standoffs or bosses, a dual rectifier alternator interconnected with the SRE housing can provide twice the amperage carrying capacity and double the cooling surface area to keep the diodes cool, thereby providing more power, less heat problems, and greater reliability.

While the invention has been described with references to its preferred embodiments, it will be understood by those skilled in the art that various changes may be made and equivalents may be substituted for elements thereof without departing from the true spirit and scope of the invention. In addition, many modifications may be made to adapt a particular situation or material to the teaching of the invention without departing from its essential teachings.

1. A slip ring end (SRE) housing for a dual rectifier alternator, the SRE housing comprising:
a base with an outer surface and an inner surface;
a plurality of standoffs coupled to said base;
a first rectifier attached to the outer surface of the base;
a second rectifier attached to the inner surface of the base; and
a connector which passes through the base and electrically interconnects the first rectifier to the second rectifier in parallel to provide rectifier redundancy in an event of a rectifier failure of either one the first and second rectifiers;
wherein said first rectifier is a diode bridge, said second rectifier is a diode bridge; said first rectifier and said second rectifier are electrically connected in parallel so as to form a redundant parallel diode bridge;
whereby upon failure of either of said first rectifier and said second rectifier, operation will be maintained by the respective other of said second rectifier and said first rectifier.

2. The SRE housing according to claim 1, wherein the SRE housing is configured in the form of an SRE housing selected from the group consisting of a 10SI, 12SI, 15SI, 17SI, 21SI, 22SI, 27SI, CS130, and CS144 alternator housing.

3. (canceled)

4. The SRE housing according to claim 1, wherein the standoffs are integrally formed on the outer surface of the base.

5. The SRE housing according to claim 1, wherein the first rectifier includes six diodes.

6. The SRE housing according to claim 1, wherein the second rectifier includes six diodes.

7. The SRE housing according to claim 1, further comprising a plurality of fasteners to attach the first rectifier to the outer surface of the base.

8. The SRE housing according to claim 1, further comprising a plurality of fasteners to attach the second rectifier to the inner surface of the base.

9. The SRE housing according to claim 1, further comprising an insulator shield for the first rectifier and an insulator shield for the second rectifier.

10. The SRE housing according to claim 1, in combination with an alternator.

11. A slip ring end (SRE) housing method comprising:
providing an SRE housing with a base with an outer surface and an inner surface;
providing a plurality of standoffs coupled to the base;
attaching a first rectifier to the outer surface of the base;
attaching a second rectifier to the inner surface of the base; and
electrically interconnecting the first rectifier to the second rectifier in parallel with a connector which passes through the base to provide rectifier redundancy in an event of a rectifier failure of either one the first and second rectifiers;
wherein the first rectifier is a diode bridge, the second rectifier is a diode bridge; the first rectifier and the second rectifier are electrically connected in parallel so as to form a redundant parallel diode bridge;
whereby upon failure of either of the first rectifier and the second rectifier, operation will be maintained by the respective other of the second rectifier and the first rectifier.

12. The SRE housing method according to claim 11, wherein the providing an SRE housing step further comprises configuring the SRE housing in the form of an SRE housing selected from the group consisting of a 10SI, 12SI, 15SI, 17SI, CS130, and CS144 alternator housing.

13. (canceled)

14. The SRE housing method according to claim 11, further comprising integrally forming the standoffs on the outer surface of the base.

15. The SRE housing method according to claim 11, further comprising providing the first rectifier with six diodes.

16. The SRE housing method according to claim 11, further comprising providing the second rectifier with six diodes.

17. The SRE housing method according to claim 11, further comprising attaching the first rectifier to the outer surface of the base with a plurality of fasteners.

18. The SRE housing method according to claim 11, further comprising attaching the second rectifier to the inner surface of the base with a plurality of fasteners.

19. The SRE housing method according to claim 11, further comprising:
providing an insulator shield for the first rectifier; and
providing an insulator shield for the second rectifier.

20. The SRE housing method according to claim 11, further comprising interconnecting an alternator with the SRE housing.
